(19) United States
(12) Patent Application Publication
(10) Pub. No.: US 2015/0113321 A1
(43) Pub. Date: Apr. 23, 2015

(54) COMPUTER SYSTEM AND METHOD FOR RECOVERING BIOS OF COMPUTER SYSTEM

(71) Applicants: HON HAI PRECISION INDUSTRY CO., LTD., New Taipei (TW); HONG FU JIN PRECISION INDUSTRY (WuHan) CO., LTD., WuHan (CN)

(72) Inventors: HUNG-CHI HUANG, New Taipei (TW); CHING-JOU CHEN, New Taipei (TW)

(73) Assignees: HON HAI PRECISION INDUSTRY CO., LTD., New Taipei (TW); HONG FU JIN PRECISION INDUSTRY (WuHan) CO., LTD., Wuhan (CN)

(21) Appl. No.: 14/073,916

(22) Filed: Nov. 7, 2013

(30) Foreign Application Priority Data
Oct. 23, 2013 (TW) 102138338

(51) Int. Cl. G06F 11/14; G06F 11/22; G06F 11/10

(52) U.S. Cl. CPC G06F 11/1448; G06F 11/1004; G06F 11/2284; G06F 2011/2278
USPC 714/15

(57) ABSTRACT

In a method for recovering a BIOS of a computer system, the computer system includes a serial peripheral interface (SPI) ROM and a storage device. The SPI ROM stores a BIOS booting block and a main BIOS, and the storage device stores a backup BIOS. The BIOS booting block of the SPI ROM is locked in a normal operating state of the computer system, and the main BIOS is checked to determine whether the main BIOS is damaged when the computer system is powered on. The BIOS booting block of the SPI ROM is unlocked when the main BIOS is damaged, and the BIOS booting block is enable to recover the main BIOS according to a backup BIOS stored in the storage device. After the main BIOS has been recovered successfully, the computer system boots normally and enters an operating system (OS) successfully.

### BACKGROUND

1. Technical Field

Embodiments of the present disclosure relate to computer error recovery systems and methods, and particularly to a computer system and method for recovering a basic input/output system (BIOS) of the computer system.

2. Description of Related Art

While booting a computer system, a basic input/output system (BIOS) of the computer system is initiated. When the BIOS is executed, a power-on self test (POST) is performed to make sure that hardware of the computer system can be normally operated. When the POST is finished, the BIOS tries to read a sector of the hard disk which is called the master boot record (MBR). The data in the MBR are loaded into a memory to be executed, and then data provided by an operating system (OS) is loaded to enter the operating system.

If errors occur in the BIOS, the BIOS stored in a flash memory of the computer system needs to be recovered to boot the computer system normally. However, it is difficult or problematic to recover the BIOS if main program codes of the BIOS are damaged. Thus, the computer system needs to be sent back to the original manufacturer to recover the BIOS.

### BRIEF DESCRIPTION OF THE DRAWINGS

FIG. 1 is a block diagram of one embodiment of a computer system including a BIOS recovery system.

FIG. 2 is a block diagram illustrating function modules of the BIOS recovery system of FIG. 1.

FIG. 3 is a flowchart of one embodiment of a method for recovering a BIOS of the computer system.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In the present disclosure, the word “module,” as used herein, refers to logic embodied in hardware or firmware, or to a collection of software instructions, written in a program language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable media or storage medium. Some non-limiting examples of a non-transitory computer-readable medium include CDs, DVDs, flash memory, and hard disk drives.

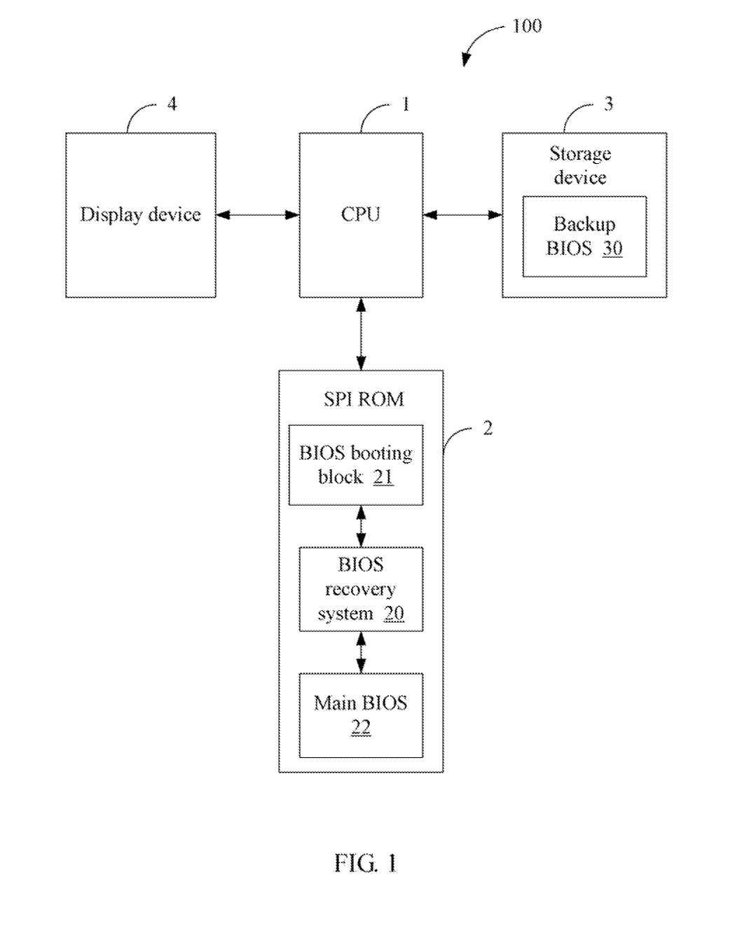

FIG. 1 is a block diagram of one embodiment of a computer system 100 including a BIOS recovery system 20. In the embodiment, the BIOS recovery system 20 is implemented by a processor of the computer system 100. The computer system 100 includes, but is not limited to, at least one processor 1, a serial peripheral interface (SPI) ROM 2, a storage device 3, and a display device 4. The processor 1 connects to the SPI ROM 2, the storage device 3, and the display device 4 through a data bus such as a SPI bus. In one embodiment, the computer system 100 may be a personal computer, a server computer, a workstation computer, a notebook computer, or other computing device.

The at least one processor 1 is a central processing unit (CPU) or microprocessor that performs various functions of the computer system 100. In one embodiment, the storage device 3 may be an internal storage system, such as a flash memory, a random access memory (RAM) for temporary storage of information, and/or a read only memory (ROM) for permanent storage of information. The storage device 3 may also be an external storage system, such as an external hard disk, a storage card, or a data storage medium.

The SPI ROM 3 is a BIOS memory that stores a BIOS booting block 21 and a main BIOS 22. In the embodiment, the BIOS recovery system 20 can communicate with the BIOS booting block 21 and the main BIOS 22 when errors occurs in the main BIOS 22. The BIOS booting block 21 invokes the main BIOS 22 to perform a power-on self test (POST) for the computer system 100 when the computer system 100 is powered on. The main BIOS 22 is executed to perform the POST process of the computer system 100 and loads an operating system (OS) of the computer system 100.

The storage device 3 stores a backup BIOS 30, which is identical to the main BIOS 22 stored in the SPI ROM 2. The backup BIOS 30 is used to recover the main BIOS 22 when the main BIOS 22 of the SPI ROM 2 is damaged, so as to make sure that the computer system 100 boots normally.

In one embodiment, the BIOS recovery system 20 may comprise computerized instructions in the form of one or more program codes that are embedded in the SPI ROM 3. The computer booting system 20 may also be stored in a non-transitory computer-readable medium such as the storage device 3. The BIOS recovery system 20 locks the BIOS booting block 21 to disable the BIOS booting block 21 when the computer system 100 works normally, and unlocks the BIOS booting block 21 to recover the main BIOS 22 of the SPI ROM 2 using the backup BIOS 30 of the storage device 3 when the main BIOS 22 is damaged.

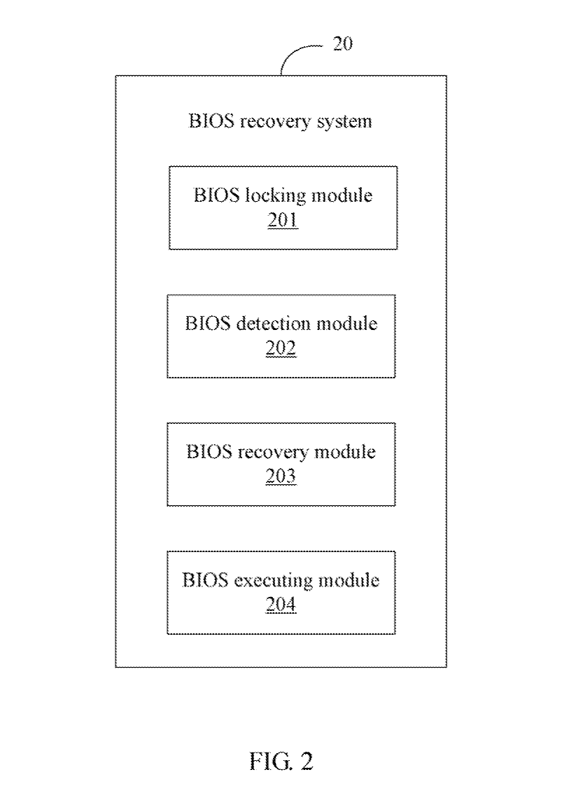

FIG. 2 is a block diagram illustrating function modules of the BIOS recovery system 20. In the embodiment, the BIOS recovery system 20 includes a BIOS locking module 201, a BIOS detection module 202, a BIOS recovery module 203, and a BIOS executing module 204. The modules 201-204 may comprise computerized instructions in the form of one or more computer-readable programs that are stored in a non-transitory computer-readable medium (such as the SPI ROM 2 or the storage device 3) and executed by the at least one processor 1. A description of each module is given in the following paragraphs.

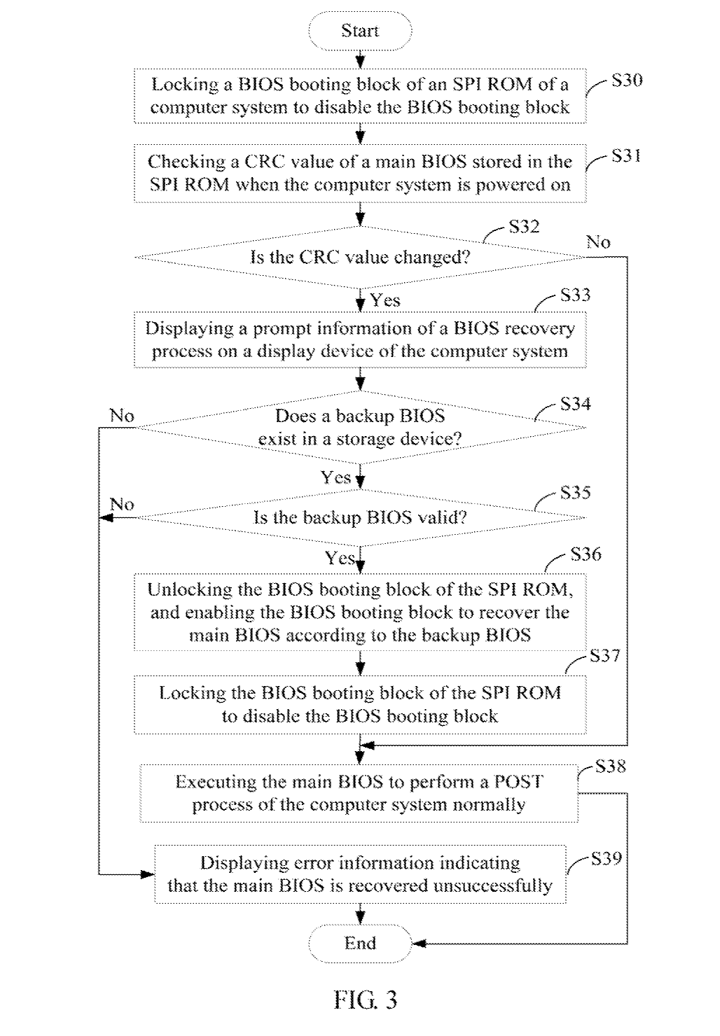

FIG. 3 is a flowchart of one embodiment of a method for a basic input/output system (BIOS) of the computer system 100. In the embodiment, the method is performed by execution of computer-readable software program codes or instructions by the at least one processor 1 of the computer system 100. The method can lock the BIOS booting block 21 when the computer system 100 works normally, and unlocks the BIOS booting block 21 to recover the main BIOS 22 using the backup BIOS 30 when the main BIOS 22 is damaged. Depending on the embodiment, additional steps may be added, others removed, and the ordering of the steps may be changed.

In step S30, the BIOS locking module 201 locks the BIOS booting block 21 of the SPI ROM to disable the BIOS booting block 21 in a normal operating state of the computer system 100. In the embodiment, the SPI ROM 21 is a BIOS memory that stores the BIOS booting block 21 and the main BIOS 22. The BIOS booting block 21 is always locked when the computer system 100 works normally, so that the BIOS booting block 21 is protected being written by the computer system 100.

In step S31, the BIOS detection module 202 checks a cyclic redundancy check (CRC) value of the main BIOS 22 when the computer system 100 is powered on. In the embodiment, the CRC value of the main BIOS 22 is a checksum code that is used to check whether errors occur in the main BIOS 22.

In step S32, the BIOS detection module 202 checks whether the CRC value of the main BIOS 22 is changed to determine whether the main BIOS 22 is damaged. In the embodiment, the BIOS detection module 202 determines whether the current CRC value of the main BIOS 22 is equal to the original CRC value of the main BIOS 22 to check whether the CRC value of the main BIOS 22 is changed. If the CRC value of the main BIOS 22 is changed, that is, the main BIOS 22 is damaged, step S33 is implemented. Otherwise, if the CRC value of the main BIOS 22 is not changed, the flow ends.

In step S33, the BIOS detection module 202 displays a prompt information of a BIOS recovery process on the display device 4 of the computer system 100. The prompt information may indicate that the main BIOS 22 is damaged and recovered using the backup BIOS 30.

In step S34, the BIOS recovery module 203 checks whether the backup BIOS 30 exists in the storage device 3. If the backup BIOS 30 exists in the storage device 3, step S36 is implemented. If the backup BIOS 30 does not exist in the storage device 3, step S39 is implemented.

In step S35, the BIOS recovery module 203 determines whether the backup BIOS 30 is valid or invalid. If the backup BIOS 30 is valid, step S36 is implemented. If the backup BIOS 30 is invalid, step S39 is implemented.

In step S36, the BIOS recovery module 203 unlocks the BIOS booting block 21 of the SPI ROM 2, and enables the BIOS booting block 21 to recover the main BIOS 22 according to the backup BIOS 30 of the storage device 3.

In step S37, the BIOS locking module 201 locks the BIOS booting block 21 of the SPI ROM 2 to disable the BIOS booting block 21. In the embodiment, the BIOS booting block 21 is locked after the main BIOS 22 has been recovered using the BIOS booting block 21.

In step S38, the BIOS executing module 204 executes the main BIOS 21 to perform a POST process of the computer system 100 normally and load an OS of the computer system 100. In the embodiment, the computer system 100 enters the OS after the computer system 100 boots successfully.

In step S39, the BIOS executing module 204 displays error information on the display device 4 of the computer system 100, the error information indicates that the main BIOS is recovered unsuccessfully.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A computer system, comprising:
a serial peripheral interface (SPI) ROM that stores a BIOS booting block and a main BIOS;
at least one processor; and
a storage device storing a computer-readable program including instructions that, which when executed by the at least one processor, causes the at least one processor to:
lock the BIOS booting block of the SPI ROM to disable the BIOS booting block in a normal operating state of the computer system;
check whether the main BIOS is damaged when the computer system is powered on;
unlock the BIOS booting block of the SPI ROM when the main BIOS is damaged; and
enable the BIOS booting block to recover the main BIOS according to a backup BIOS stored in the storage device.

2. The computer system according to claim 1, wherein the computer-readable program further causes the at least one processor to:
execute the main BIOS to perform a power-on self test (POST) process of the computer system normally when the main BIOS has been recovered successfully or the main BIOS is not damaged.

3. The computer system according to claim 1, wherein the computer-readable program further causes the at least one processor to:
display a prompt information for indicating a BIOS recovery process on a display device of the computer system during the process of recovering the main BIOS.

4. The computer system according to claim 1, wherein the main BIOS is checked by steps of:
checking a cyclic redundancy check (CRC) value of the main BIOS; and
checking whether the CRC value of the main BIOS is changed to determine whether the main BIOS is damaged.

5. The computer system according to claim 1, wherein the computer-readable program further causes the at least one processor to:
check whether the backup BIOS exists in the storage device; and
determine whether the backup BIOS is valid when the backup BIOS exists in the storage device.

6. The computer system according to claim 5, wherein the computer-readable program further causes the at least one processor to:
display error information on a display device of the computing system if the backup BIOS does not exist in the storage device or the backup BIOS is invalid, the error information indicating that the main BIOS is recovered unsuccessfully.

7. A method for recovering a BIOS of a computer system, the computer system comprising a serial peripheral interface (SPI) ROM and a storage device, the method comprising:
locking a BIOS booting block stored in the SPI ROM to disable the BIOS booting block in a normal operating state of the computer system;
checking whether a main BIOS stored in the SPI ROM is damaged when the computer system is powered on;
unlocking the BIOS booting block of the SPI ROM when the main BIOS is damaged; and
enabling the BIOS booting block to recover the main BIOS according to a backup BIOS stored in the storage device.

8. The method according to claim 7, further comprising:
executing the main BIOS to perform a power-on self test (POST) process of the computer system normally when the main BIOS has been recovered successfully or the main BIOS is not damaged.

9. The method according to claim 7, further comprising:
displaying a prompt information for indicating a BIOS recovery process on a display device of the computer system during the process of recovering the main BIOS.

10. The method according to claim 7, wherein the main BIOS is checked by steps of:
checking a cyclic redundancy check (CRC) value of the main BIOS; and
checking whether the CRC value of the main BIOS is changed to determine whether the main BIOS is damaged.

11. The method according to claim 7, further comprising:
checking whether the backup BIOS exists in the storage device; and
determining whether the backup BIOS is valid when the backup BIOS exists in the storage device.

12. The method according to claim 11, further comprising:
displaying error information on a display device of the computing system if the backup BIOS does not exist in the storage device or the backup BIOS is invalid, the error information indicating that the main BIOS is recovered unsuccessfully.

13. A non-transitory storage medium having stored thereon instructions that, when executed by at least one processor of a computer system, causes the processor to perform a method for recovering a BIOS of the computer system, the computer system comprising a serial peripheral interface (SPI) ROM and a storage device, the method comprising:
locking a BIOS booting block stored in the SPI ROM to disable the BIOS booting block in a normal operating state of the computer system;
checking whether a main BIOS stored in the SPI ROM is damaged when the computer system is powered on;
unlocking the BIOS booting block of the SPI ROM when the main BIOS is damaged; and
enabling the BIOS booting block to recover the main BIOS according to a backup BIOS stored in the storage device.

14. The storage medium according to claim 13, wherein the method further comprises:
executing the main BIOS to perform a power-on self test (POST) process of the computer system normally when the main BIOS has been recovered successfully or the main BIOS is not damaged.

15. The storage medium according to claim 13, wherein the method further comprises:
displaying a prompt information for indicating a BIOS recovery process on a display device of the computer system during the process of recovering the main BIOS.

16. The storage medium according to claim 13, wherein the main BIOS is checked by steps of:
checking a cyclic redundancy check (CRC) value of the main BIOS; and
checking whether the CRC value of the main BIOS is changed to determine whether the main BIOS is damaged.

17. The storage medium according to claim 13, wherein the method further comprises:
checking whether the backup BIOS exists in the storage device; and
determining whether the backup BIOS is valid when the backup BIOS exists in the storage device.

18. The storage medium according to claim 17, wherein the method further comprises:
displaying error information on a display device of the computing system if the backup BIOS does not exist in the storage device or the backup BIOS is invalid, the error information indicating that the main BIOS is recovered unsuccessfully.
